(19) United States
(12) Patent Application Publication
(10) Pub. No.: US 2021/0158442 A1
(43) Pub. Date: May 27, 2021

(54) CREDIT EVALUATION METHODS AND APPARATUSES, AND ELECTRONIC DEVICES

(71) Applicant: Advanced New Technologies Co., Ltd., George Town (KY)

(72) Inventors: Jiahui Cui, Hangzhou (CN); Zheng Liu, Hangzhou (CN); Shan Yin, Hangzhou (CN)

(73) Assignee: Advanced New Technologies Co., Ltd., George Town (KY)

(21) Appl. No.: 17/163,235

(22) Filed: Jan. 29, 2021

Related U.S. Application Data
(63) Continuation of application No. PCT/CN2019/103093, filed on Aug. 28, 2019.

(30) Foreign Application Priority Data
Oct. 26, 2018 (CN) 201811260940.9

(51) Int. Cl. G06Q 40/02; H04L 9/06

(52) U.S. Cl. CPC G06Q 40/025; H04L 2209/38; H04L 9/0618; H04L 9/0643

(57) ABSTRACT

Credit evaluation processing includes obtaining, by a certifier, credit proof data provided by an endorser, wherein a hash value corresponding to the credit proof data is recorded in a blockchain by the endorser; applying, by the certifier, a credit evaluation function to the credit proof data to obtain a credit evaluation result to be verified; generating, by the certifier, zero-knowledge proof information for the credit evaluation result to be verified; and sending, by the certifier, the credit evaluation result to be verified and the zero-knowledge proof information to a verifier that confirms the credit evaluation result to be trustable when the verifier determines, based on the zero-knowledge proof information, that: the credit evaluation result is generated by the credit evaluation function, calculation parameters of the credit evaluation function used to generate the credit evaluation result to be verified match the hash value corresponding to the credit proof data.

### CROSS-REFERENCE TO RELATED APPLICATIONS

This application is a continuation of PCT Application No. PCT/CN2019/103093, filed on Aug. 28, 2019, which claims priority to Chinese Patent Application No. 201811260940.9, filed on Oct. 26, 2018, and each application is hereby incorporated by reference in its entirety.

### TECHNICAL FIELD

One or more embodiments of the present specification relate to the field of blockchain technologies, and in particular, to credit evaluation methods and apparatuses, and electronic devices.

### BACKGROUND

In the process of credit evaluation, there are three roles: a certifier, a verifier, and an endorser. The verifier needs to evaluate the credit status of the certifier, and the data needed for the evaluation is stored by the endorser. Based on privacy considerations, the endorser does not disclose related data of the certifier. With authorization from the certifier, the related data can be obtained from the endorser and then provided to the verifier for credit evaluation.

### SUMMARY

In view of this, one or more embodiments of the present specification provide credit evaluation methods and apparatuses, and electronic devices.

To achieve the previously described objective, one or more embodiments of the present specification provide the following technical solutions.

According to a first aspect of the one or more embodiments of the present specification, a credit evaluation method is provided and applied to a certifier, and the method includes the following: obtaining credit proof data provided by an endorser, where a hash value corresponding to the credit proof data is recorded in a blockchain by the endorser; performing calculation processing on the credit proof data by using a credit evaluation function, to obtain a credit evaluation result to be verified; generating zero-knowledge proof information for the credit evaluation result to be verified; and sending the credit evaluation result to be verified and the zero-knowledge proof information to a verifier, where the credit evaluation result to be verified is confirmed to be trustable when the verifier determines, based on the zero-knowledge proof information, that the credit evaluation result to be verified is generated by the credit evaluation function, and calculation parameters used to generate the credit evaluation result to be verified matches the hash value corresponding to the credit proof data.

According to a second aspect of the one or more embodiments of the present specification, a credit evaluation method is provided and applied to a verifier, and the method includes the following: receiving a credit evaluation result to be verified and zero-knowledge proof information that are provided by a certifier; based on the zero-knowledge proof information, verifying whether the following conditions are satisfied: the credit evaluation result to be verified is generated by a credit evaluation function, and calculation parameters used to generate the credit evaluation result to be verified match a hash value recorded in a blockchain by an endorser, where the hash value corresponds to credit proof data of the certifier recorded by the endorser; and confirming that the credit evaluation result to be verified is trustable when the zero-knowledge proof information satisfies the previously described conditions.

According to a third aspect of the one or more embodiments of the present specification, a credit evaluation apparatus is provided and applied to a certifier, and the apparatus includes the following: a data acquisition unit, configured to obtain credit proof data provided by an endorser, where a hash value corresponding to the credit proof data is recorded in a blockchain by the endorser; a calculation unit, configured to perform calculation processing on the credit proof data by using a credit evaluation function, to obtain a credit evaluation result to be verified; a generation unit, configured to generate zero-knowledge proof information for the credit evaluation result to be verified; and a sending unit, configured to send the credit evaluation result to be verified and the zero-knowledge proof information to a verifier, where the credit evaluation result to be verified is confirmed to be trustable when the verifier determines, based on the zero-knowledge proof information, that the credit evaluation result to be verified is generated by the credit evaluation function, and calculation parameters used to generate the credit evaluation result to be verified match the hash value corresponding to the credit proof data.

According to a fourth aspect of the one or more embodiments of the present specification, a credit evaluation apparatus is provided and applied to a verifier, and the apparatus includes the following: a first receiving unit, configured to receive a credit evaluation result to be verified and zero-knowledge proof information that are provided by a certifier; a verifying unit, configured to verify, based on the zero-knowledge proof information, whether the following conditions are satisfied: the credit evaluation result to be verified is generated by a credit evaluation function, and calculation parameters used to generate the credit evaluation result to be verified match a hash value recorded in a blockchain by an endorser, where the hash value corresponds to credit proof data of the certifier recorded by the endorser; and a confirmation unit, configured to confirm that the credit evaluation result to be verified is trustable when the zero-knowledge proof information satisfies the previously described conditions.

According to a fifth aspect of the one or more embodiments of the present specification, an electronic device is provided and includes the following: a processor; and a memory configured to store a processor-executable instruction, where the processor executes the executable instruction to perform the method according to any embodiments of the first aspect.

According to a sixth aspect of the one or more embodiments of the present specification, an electronic device is provided and includes the following: a processor; and a memory configured to store a processor-executable instruction, where the processor executes the executable instruction to perform the method according to any embodiments of the second aspect.

### BRIEF DESCRIPTION OF DRAWINGS

FIG. 1 is a flowchart illustrating a credit evaluation method, according to an example embodiment;

FIG. 2 is a flowchart illustrating another credit evaluation method, according to an example embodiment;

FIG. 3 is a diagram illustrating interaction to evaluate a user credit status, according to an example embodiment;

FIG. 4 is a diagram illustrating a structure of a device, according to an example embodiment;

FIG. 5 is a block diagram illustrating an apparatus, according to an example embodiment;

FIG. 6 is a diagram illustrating a structure of another device, according to an example embodiment; and

FIG. 7 is a block diagram illustrating another apparatus, according to an example embodiment.

### DESCRIPTION OF EMBODIMENTS

Example embodiments are described in detail here, and examples of the example embodiments are presented in the accompanying drawings. When the following description relates to the accompanying drawings, unless specified otherwise, same numbers in different accompanying drawings represent same or similar elements. Implementations described in the following example embodiments do not represent all implementations consistent with the present specification. On the contrary, the implementations are only examples of apparatuses and methods that are described in the appended claims in detail and consistent with some aspects of the present specification.

It is worthwhile to note that, steps of corresponding methods in other embodiments are not necessarily performed in the order shown and described in the present specification. Methods in some other embodiments can include more or less steps than those described in the present specification. In addition, a single step described in the present specification may be divided into a plurality of steps for description in other embodiments, and a plurality of steps described in the present specification may also be combined into a single step for description in other embodiments.

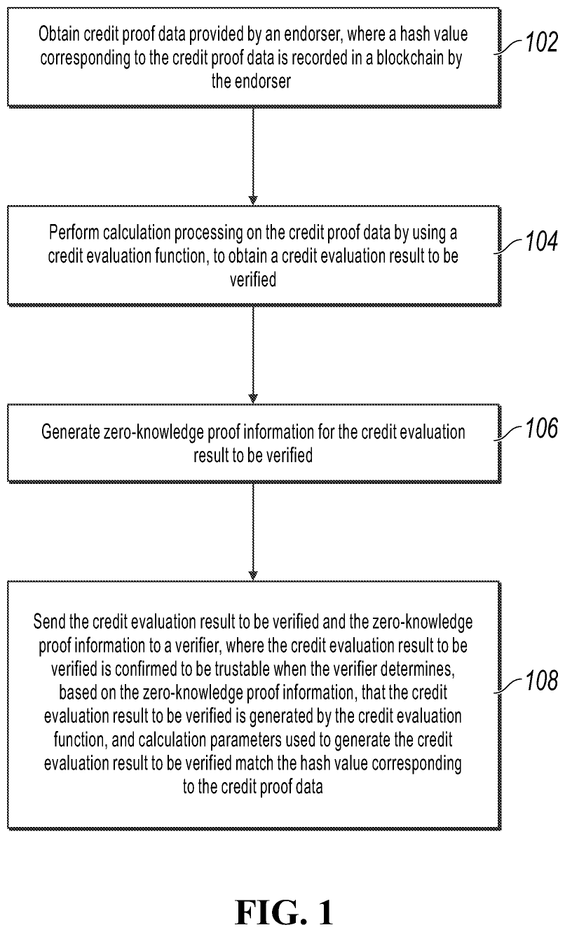

FIG. 1 is a flowchart illustrating a credit evaluation method, according to an example embodiment. As shown in FIG. 1, the method is applied to a certifier and can include the following steps.

Step 102: Obtain credit proof data provided by an endorser, where a hash value corresponding to the credit proof data is recorded in a blockchain by the endorser.

In some embodiments, the endorser is used to store, protect, and endorse the credit proof data of the certifier, and the credit proof data can be used to prove a credit status of the certifier. The credit proof data is private, and the endorser does not directly provide the credit proof data to a verifier etc., to avoid the leakage of the privacy data.

In some embodiments, the endorser can deploy a transaction in the blockchain so that the hash value is recorded in the blockchain. The transaction (transaction) in the present specification refers to data that is created by a user by using a client device of the blockchain and that needs to be finally deployed in a distributed database of the blockchain. There are a transaction in a narrow sense and a transaction in a broad sense in the blockchain. The transaction in a narrow sense refers to value transfer deployed by the user to the blockchain. For example, in a conventional bitcoin blockchain network, the transaction can be transfer initiated by the user in the blockchain. However, the transaction in a broad sense refers to service data that is deployed by the user to the blockchain and that has a service intention. For example, an operator can establish a consortium blockchain based on actual service needs, and deploy some other types of online services (such as a credit evaluation service, a house rental service, a vehicle scheduling service, an insurance claim service, a credit service, and a medical service) unrelated to value transfer depending on the consortium blockchain. In such a consortium blockchain, the transaction can be a service message or a service request that is deployed by the user to the consortium blockchain and that has a service intention.

In some embodiments, the hash value can be obtained by the endorser by hashing the credit proof data and a random number, to avoid exhaustive attacks caused by too small value space, thereby helping to improve reliability. The certifier can obtain the random number that corresponds to the hash value and that is provided by the endorser, and verify a mapping relationship between the credit proof data, the random number, and the hash value, to avoid problems such as the endorser updates the credit proof data but does not update the hash value in time, thereby avoiding the failure of a verification operation performed by the verifier.

In some embodiments, the endorser can use a private key of the endorser to add a signature to the hash value recorded in a blockchain ledger, and can also add signatures when providing the credit proof data, a certificate of deposit, etc. to the certifier, to ensure the reliability of related data, indicating that the related data has not been tampered with.

Step 104: Perform calculation processing on the credit proof data by using a credit evaluation function, to obtain a credit evaluation result to be verified.

In some embodiments, the credit evaluation function can be a default function, and the calculation parameters used by the credit evaluation function are default parameters. The certifier can know the default function and the calculation parameters based on default settings. The verifier also knows the default function and can verify the credit evaluation result to be verified based on the default function.

In some embodiments, the verifier can send a credit evaluation function that the verifier expects to use and calculation parameters of the credit evaluation function to the certifier, so that the certifier processes the related calculation parameters based on the credit evaluation function to obtain the credit evaluation result to be verified. Therefore, the verifier can easily perform processing such as adjustment (such as using different versions of functions for different certifiers) and upgrade on the credit evaluation function to be used and the calculation parameters of the credit evaluation function. In addition, operations such as the certifier calculating the credit evaluation result to be verified and the verifier sending the credit evaluation function and the calculation parameters of the credit evaluation function to the certifier are performed outside of the blockchain, and do not need to be deployed or recorded to the blockchain ledger. Therefore, the credit evaluation function etc. is not disclosed, and the verifier does not need to worry about the leakage of a calculation method used by the credit evaluation function.

Step 106: Generate zero-knowledge proof information for the credit evaluation result to be verified.

In some embodiments, based on the zero-knowledge proof (Zero-Knowledge Proof) technology in related technologies, the certifier can generate the corresponding zero-knowledge proof information for the credit evaluation result to be verified, so that the verifier can verify the credit evaluation result to be verified with no need to know the credit proof data. Therefore, the leakage of the credit proof data can be avoided, and the verification requirement can be satisfied. For example, the present specification can use any type of zero-knowledge proof technology such as Zero-Knowledge Succinct Non-Interactive Argument of Knowledge (zk-SNARK) in the related technologies, which is not limited in the present specification.

Step 108: Send the credit evaluation result to be verified and the zero-knowledge proof information to a verifier, where the credit evaluation result to be verified is confirmed to be trustable when the verifier determines, based on the zero-knowledge proof information, that the credit evaluation result to be verified is generated by the credit evaluation function, and calculation parameters used to generate the credit evaluation result to be verified match the hash value corresponding to the credit proof data.

In some embodiments, the endorser only needs to record the hash value of the credit proof data of the certifier in the blockchain, to ensure that the verifier can verify the credit evaluation result to be verified provided by the certifier by using the technical solutions in the present specification, with no need to provide plaintext content of the credit proof data to the outside (except the certifier). Therefore, the leakage of the credit proof data can be avoided, the certifier can be prevented from tampering with the credit proof data, and the verifier can be prevented from violating rules in the verification process.

In some embodiments, the certifier can obtain a certificate of deposit that corresponds to the hash value and that is provided by the endorser. For example, the certificate of deposit can include a location (such as a block that the hash value is located in, or a serial number of the transaction that the hash value is located in) of the hash value in the blockchain ledger, and the hash value. The certifier can send the certificate of deposit to the verifier so that the verifier identifies the hash value from the blockchain based on the certificate of deposit, to verify the credit evaluation result to be verified. Certainly, the verifier can also use other methods to identify the hash value from the blockchain, for example, the verifier can directly request the hash value from the endorser. This is not limited in the present specification.

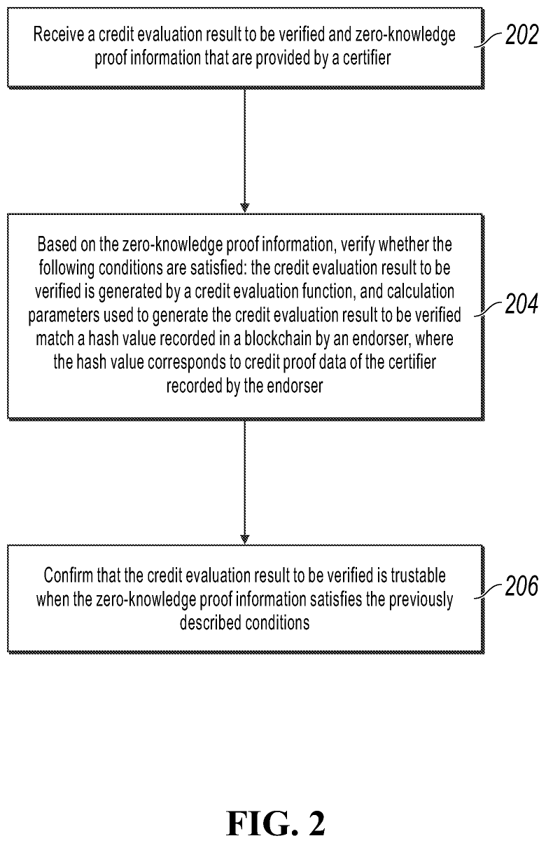

FIG. 2 is a flowchart illustrating another credit evaluation method, according to an example embodiment. As shown in FIG. 2, the method is applied to a verifier and can include the following steps.

Step 202: Receive a credit evaluation result to be verified and zero-knowledge proof information that are provided by a certifier.

Step 204: Based on the zero-knowledge proof information, verify whether the following conditions are satisfied: the credit evaluation result to be verified is generated by a credit evaluation function, and calculation parameters used to generate the credit evaluation result to be verified match a hash value recorded in a blockchain by an endorser, where the hash value corresponds to credit proof data of the certifier recorded by the endorser.

In some embodiments, the endorser is used to store, protect, and endorse the credit proof data of the certifier, and the credit proof data can be used to prove a credit status of the certifier. The credit proof data is private, and the endorser does not directly provide the credit proof data to a verifier etc., to avoid the leakage of the privacy data.

In some embodiments, the endorser can deploy a transaction in the blockchain so that the hash value is recorded in the blockchain. The transaction in the present specification refers to data that is created by a user by using a client device of the blockchain and that needs to be finally deployed in a distributed database of the blockchain. There are a transaction in a narrow sense and a transaction in a broad sense in the blockchain. The transaction in a narrow sense refers to value transfer deployed by the user to the blockchain. For example, in a conventional bitcoin blockchain network, the transaction can be transfer initiated by the user in the blockchain. However, the transaction in a broad sense refers to service data that is deployed by the user to the blockchain and that has a service intention. For example, an operator can establish a consortium blockchain based on actual service needs, and deploy some other types of online services (such as a credit evaluation service, a house rental service, a vehicle scheduling service, an insurance claim service, a credit service, and a medical service) unrelated to value transfer depending on the consortium blockchain. In such a consortium blockchain, the transaction can be a service message or a service request that is deployed by the user to the consortium blockchain and that has a service intention.

In some embodiments, the hash value can be obtained by the endorser by hashing the credit proof data and a random number, to avoid exhaustive attacks caused by too small value space, thereby helping to improve reliability. The certifier can obtain the random number that corresponds to the hash value and that is provided by the endorser, and verify a mapping relationship between the credit proof data, the random number, and the hash value, to avoid problems such as the endorser updates the credit proof data but does not update the hash value in time, thereby avoiding the failure of a verification operation performed by the verifier.

In some embodiments, the endorser can use a private key of the endorser to add a signature to the hash value recorded in a blockchain ledger, and can also add signatures when providing the credit proof data, a certificate of deposit, etc. to the certifier, to ensure the reliability of related data, indicating that the related data has not been tampered with.

In some embodiments, the credit evaluation function can be a default function, and the calculation parameters used by the credit evaluation function are default parameters. The certifier can know the default function and the calculation parameters based on default settings. The verifier also knows the default function and can verify the credit evaluation result to be verified based on the default function.

In some embodiments, the verifier can send a credit evaluation function that the verifier expects to use and calculation parameters of the credit evaluation function to the certifier, so that the certifier processes the related calculation parameters based on the credit evaluation function to obtain the credit evaluation result to be verified. Therefore, the verifier can easily perform processing such as adjustment (such as using different versions of functions for different certifiers) and upgrade on the credit evaluation function to be used and the calculation parameters of the credit evaluation function. In addition, operations such as the certifier calculating the credit evaluation result to be verified and the verifier sending the credit evaluation function and the calculation parameters of the credit evaluation function to the certifier are performed outside of the blockchain, and do not need to be deployed or recorded to the blockchain ledger. Therefore, the credit evaluation function etc. is not disclosed, and the verifier does not need to worry about the leakage of a calculation method used by the credit evaluation function.

In some embodiments, based on the zero-knowledge proof technology in related technologies, the certifier can generate the corresponding zero-knowledge proof information for the credit evaluation result to be verified, so that the verifier can verify the credit evaluation result to be verified with no need to know the credit proof data. Therefore, the leakage of the credit proof data can be avoided, and the verification requirement can be satisfied. For example, the present specification can use any type of zero-knowledge proof technology such as zk-SNARK in the related technologies, which is not limited in the present specification.

Step 206: Confirm that the credit evaluation result to be verified is trustable when the zero-knowledge proof information satisfies the previously described conditions.

In some embodiments, the endorser only needs to record the hash value of the credit proof data of the certifier in the blockchain, to ensure that the verifier can verify the credit evaluation result to be verified provided by the certifier by using the technical solutions in the present specification, with no need to provide plaintext content of the credit proof data to the outside (except the certifier). Therefore, the leakage of the credit proof data can be avoided, the certifier can be prevented from tampering with the credit proof data, and the verifier can be prevented from violating rules in the verification process.

In some embodiments, the certifier can obtain a certificate of deposit that corresponds to the hash value and that is provided by the endorser. For example, the certificate of deposit can include a location (such as a block that the hash value is located in, or a serial number of the transaction that the hash value is located in) of the hash value in the blockchain ledger, and the hash value. The certifier can send the certificate of deposit to the verifier so that the verifier identifies the hash value from the blockchain based on the certificate of deposit, to verify the credit evaluation result to be verified. Certainly, the verifier can also use other methods to identify the hash value from the blockchain, for example, the verifier can directly request the hash value from the endorser. This is not limited in the present specification.

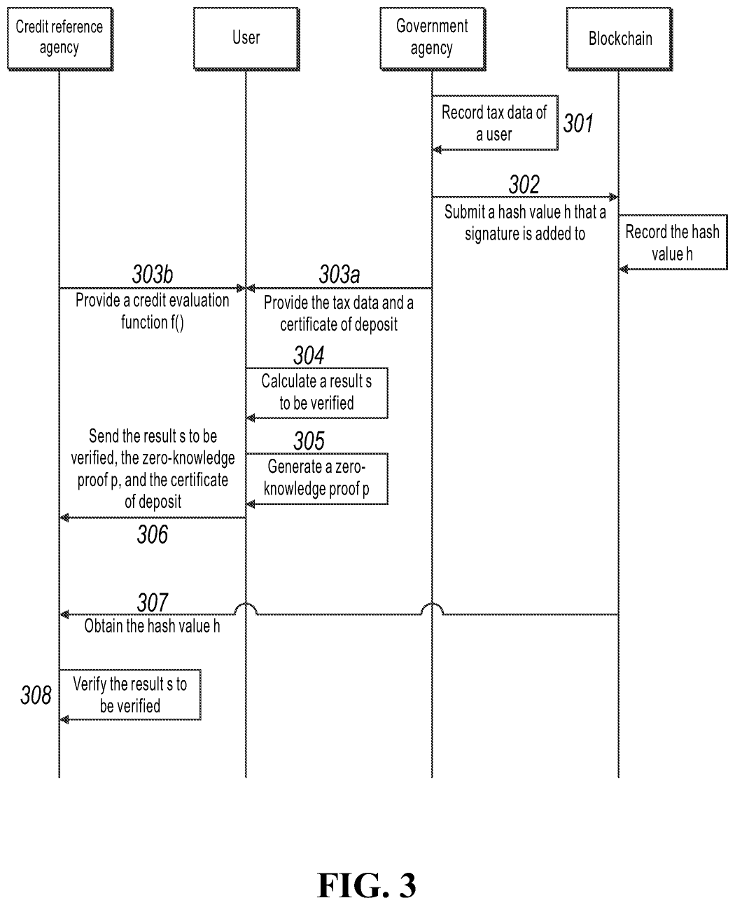

FIG. 3 is a diagram illustrating interaction to evaluate a user credit status, according to an example embodiment. Assume that a government agency saves the credit proof data of users and endorses the validity, reliability, etc. of the credit proof data. For example, the credit proof data can include tax data, etc., which is not limited in the present specification. A credit reference agency needs to calculate credit statuses of users, and this process needs to use the credit proof data such as tax data recorded by the government agency. As shown in FIG. 3, based on an interaction process among the credit reference agency, users, and the government agency in combination with the use of a blockchain, the credit statuses of the users can be effectively evaluated, and exceptions such as leakage or tampering of the credit proof data are avoided. The interaction process can include the following steps.

Step 301: The government agency records tax data of a user.

In some embodiments, the government agency can generate corresponding tax data based on tax records of the user in the tax department. The authenticity and reliability of the tax data has passed the verification of the government agency, and the government agency endorses the tax data.

Step 302: The government agency generates a hash value h corresponding to the tax data, adds a signature to the hash value h, and submits the hash value h to the blockchain, to record the hash value h in the blockchain.

In some embodiments, the government agency can perform calculation on the tax data by using a predetermined hash function H( ), to obtain the corresponding hash value h. Due to the feature of hash algorithms, a reliable mapping relationship between the tax data and the hash value h can be ensured, and the hash value h does not expose the content of the tax data. That is, the tax data cannot be deduced from the hash value h.

In some embodiments, to avoid exhaustive attacks caused by too small value space, the government agency can add a random number r when calculating the hash value h, so that the hash function H( ) is used to perform calculation on the tax data and the random number r, to obtain the hash value h. This can further ensure that the hash value h does not expose the content of the tax data, thereby improving the security.

In some embodiments, the government agency can add a signature to the hash value h by using a private key corresponding to a digital identity of the government agency. A public key of the government agency is publicly known, so that the credit reference agency, the user, etc. can verify the signature by using the public key, to ensure that the hash value h is published by the government agency and is not tampered with.

In some embodiments, the government agency can be configured as a blockchain node in the blockchain. For example, the blockchain can be a consortium blockchain, so that the government agency can deploy a transaction in the blockchain to record the hash value h in the blockchain, that is, in a blockchain ledger. Due to the distributed feature of the blockchain, the hash value h cannot be tampered with by criminals after being submitted to the blockchain and recorded in the blockchain ledger, and therefore has high security and reliability.

Step 303a: The government agency provides the tax data and a certificate of deposit to the user.

In some embodiments, when needing to generate or update credit data, the user can submit a data acquisition request to the government agency, so that after verifying the identity of the user, the government agency can provide the tax data, the certificate of deposit of the hash value h corresponding to the tax data, etc. to the user for subsequent processing.

In some embodiments, in addition to the tax data, there may be other types of credit proof data, and these credit proof data can be managed by different government agencies. By performing steps such as the previously described steps 301 and 302, these government agencies can manage and record the credit proof data maintained by them. In step 303a, the user can obtain needed tax data and a certificate of deposit of the tax data from each government agency, and details are omitted here for simplicity. The following description uses an example that the user obtains tax data and a certificate of deposit of the tax data.

Step 303b: The credit reference agency provides a credit evaluation function f( ) to the user.

In some embodiments, when needing to generate or update credit data, the user can submit a generation request or an update request to the credit reference agency, so that the credit reference agency can provide the credit evaluation function f( ) to the user. Certainly, the credit reference agency can also provide the credit evaluation function f( ) to the user on other occasions, which are not limited in the present specification.

In some embodiments, a transmission operation of the credit evaluation function f( ) between the credit reference agency and the user can be performed outside of the blockchain, and does not need to be deployed to the blockchain, so that a calculation method etc. used by the credit evaluation function f( ) cannot be divulged. In addition, the credit reference agency can perform flexible operations such as version adjustment and version updating on the transmitted credit evaluation function f( ) based on actual situations.

In some embodiments, when providing the credit evaluation function f( ), if necessary, the credit reference agency should further indicate calculation parameters that the credit evaluation function f( ) needs to use, so that the user can determine input data for the credit evaluation function f( ) based on the calculation parameters. For example, the user can first obtain the credit evaluation function f( ) from the credit reference agency, and then obtain corresponding credit proof data from a corresponding government agency based on the calculation parameters that the credit evaluation function f( ) needs to use. Certainly, the user can alternatively obtain all credit proof data from all government agencies, and then select corresponding input data for the calculation parameters that the credit evaluation function f( ) needs to use.

In some embodiments, the certificate of deposit provided by the government agency to the user can include the hash value h, the random number r used to calculate the hash value h, a location of the hash value h in the blockchain ledger, the signature of the government agency on the hash value h, etc., which are not limited in the present specification. The user can verify the signature of the hash value h, to ensure that the hash value h has not been tampered with. The user can query corresponding deposit content in the blockchain ledger based on the location of the hash value h in the blockchain ledger, to verify the consistency between the deposit content and the tax data, the random number r, etc., thereby determining the tax data corresponding to the hash value h.

Step 304: The user calculates a result s to be verified.

In some embodiments, the user performs calculation on the tax data etc. by using the credit evaluation function f( ) provided by the credit reference agency, to obtain the corresponding result s to be verified. In fact, if the tax data is true and reliable, the result s to be verified is a calculation result corresponding to the credit status of the user. However, the result s has not been verified by a verifier, and therefore is called the result s to be verified, to avoid a forged result generated by the user by using a method such as changing the credit evaluation function f( ) or tampering with the tax data.

Step 305: The user generates a zero-knowledge proof p.

In some embodiments, the user can use a zero-knowledge proof technology in related technologies to generate the zero-knowledge proof p for the result s to be verified, so that the credit reference agency can implement related certification based on the zero-knowledge proof p, to determine the validity of the result s to be verified.

Step 306: The user sends the results to be verified, the zero-knowledge proof p, and the certificate of deposit to the credit reference agency.

Step 307: The credit reference agency obtains the corresponding hash value h from the blockchain based on the certificate of deposit.

In some embodiments, the certificate of deposit provided by the user to the credit reference agency can include the hash value h, the location of the hash value h in the blockchain ledger, the signature of the government agency on the hash value h, etc., but cannot include information such as the random number r, to avoid exhaustive attacks initiated by criminals based on the random number r. The credit reference agency can be configured as a blockchain node in the blockchain. For example, the blockchain can be a consortium blockchain, so that the credit reference agency can obtain the hash value h corresponding to the tax data of the user from the blockchain ledger based on the certificate of deposit.

Certainly, in addition to using the certificate of deposit provided by the user, the credit reference agency can also use other methods to obtain the hash value h from the blockchain. This is not limited in the present specification.

Step 308: The credit reference agency verifies the result s to be verified.

In some embodiments, based on the obtained zero-knowledge proof p, the credit reference agency can verify whether the following conditions are satisfied:

(1) In a process that the certifier uses the credit evaluation function f( ) to calculate the result s to be verified, calculation parameters input by the certifier correspond to the hash value h.

(2) The certifier obtains the result s to be verified by faithfully executing the credit evaluation function f( ) instead of using another function to replace the credit evaluation function f( ).

When both the conditions (1) and (2) are satisfied, the credit reference agency can confirm that the result s to be verified is trustable, and therefore determine the credit status of the user based on the result s to be verified. Otherwise, the credit reference agency can determine that the result s to be verified is not trustable.

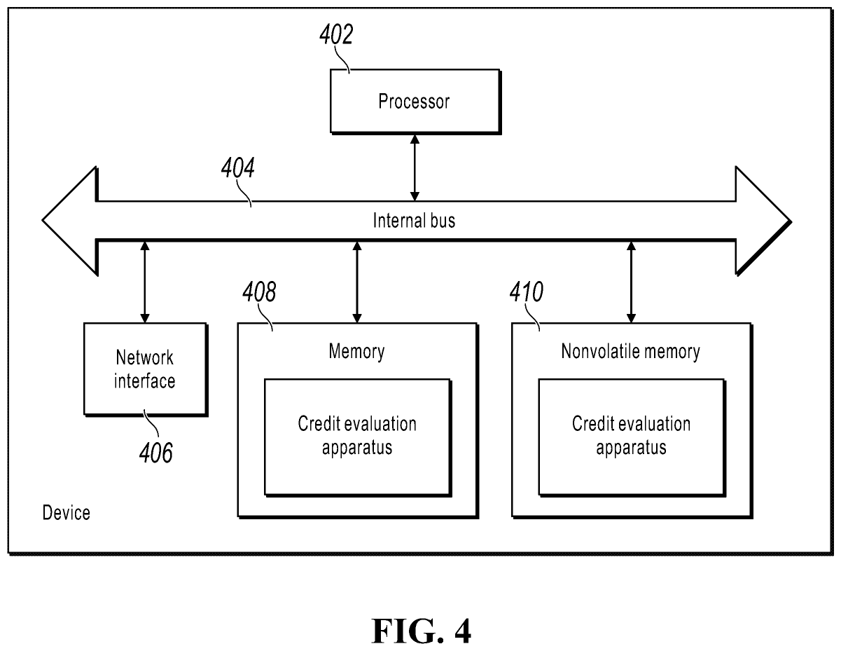

FIG. 4 is a diagram illustrating a structure of a device, according to an example embodiment. Referring to FIG. 4, at the hardware level, the device includes a processor 402, an internal bus 404, a network interface 406, a memory 408, and a nonvolatile memory 410. Certainly, the device may further include hardware needed by other services. The processor 402 reads a corresponding computer program from the nonvolatile memory 410 into the memory 408 for running, to form a credit evaluation apparatus at the logical level. Certainly, in addition to software implementations, one or more embodiments of the present specification do not exclude other implementations, such as logic devices or a combination of hardware and software. That is, an execution body of the following processing procedure is not limited to logical units, but can also be hardware or logic devices.

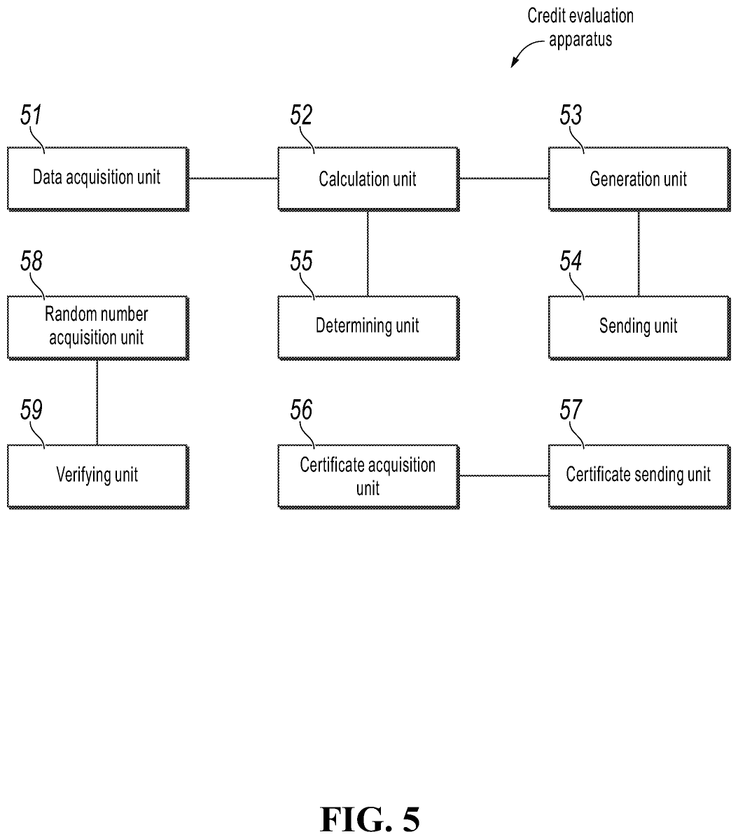

Referring to FIG. 5, in software implementations, the credit evaluation apparatus is applied to a certifier and can include the following: a data acquisition unit 51, configured to obtain credit proof data provided by an endorser, where a hash value corresponding to the credit proof data is recorded in a blockchain by the endorser; a calculation unit 52, configured to perform calculation processing on the credit proof data by using a credit evaluation function, to obtain a credit evaluation result to be verified; a generation unit 53, configured to generate zero-knowledge proof information for the credit evaluation result to be verified; and a sending unit 54, configured to send the credit evaluation result to be verified and the zero-knowledge proof information to a verifier, where the credit evaluation result to be verified is confirmed to be trustable when the verifier determines, based on the zero-knowledge proof information, that the credit evaluation result to be verified is generated by the credit evaluation function, and calculation parameters used to generate the credit evaluation result to be verified match the hash value corresponding to the credit proof data.

Optionally, the credit evaluation function is a default function, and the calculation parameters used by the credit evaluation function are default parameters; or the apparatus further includes a determining unit 55, configured to determine the credit evaluation function to be used and the calculation parameters of the credit evaluation function based on instruction information sent by the verifier.

Optionally, the apparatus further includes the following: a certificate acquisition unit 56, configured to obtain a certificate of deposit that corresponds to the hash value and that is provided by the endorser; and a certificate sending unit 57, configured to send the certificate of deposit to the verifier so that the verifier identifies the hash value from the blockchain based on the certificate of deposit.

Optionally, the certificate of deposit includes at least one of the following: the hash value and a recording location of the hash value in the blockchain.

Optionally, the hash value is obtained by the endorser by hashing the credit proof data and a random number, and the apparatus further includes the following: a random number acquisition unit 58, configured to obtain the random number that corresponds to the hash value and that is provided by the endorser; and a verifying unit 59, configured to verify a mapping relationship between the credit proof data, the random number, and the hash value.

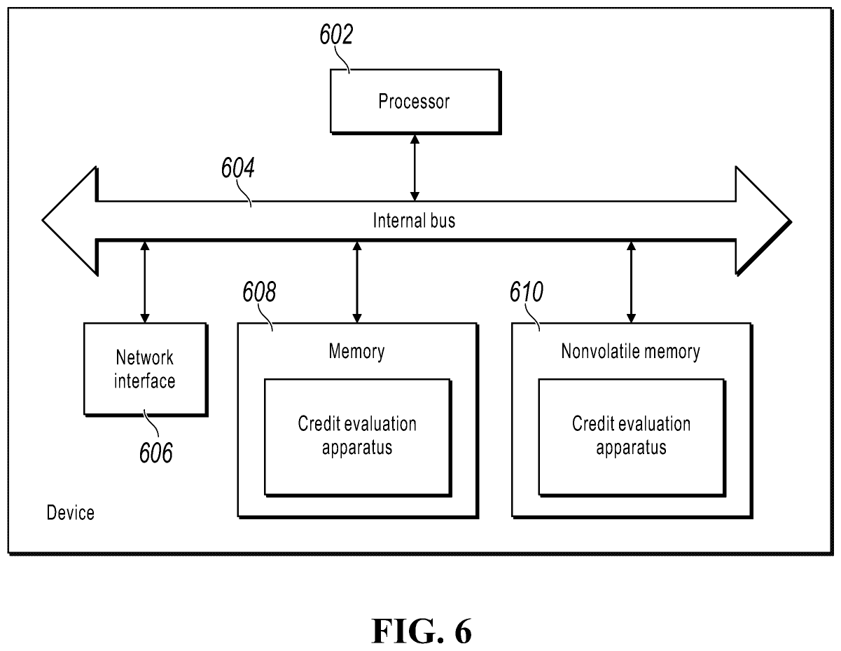

FIG. 6 is a diagram illustrating a structure of a device, according to an example embodiment. Referring to FIG. 6, at the hardware level, the device includes a processor 602, an internal bus 604, a network interface 606, a memory 608, and a nonvolatile memory 610. Certainly, the device may further include hardware needed by other services. The processor 602 reads a corresponding computer program from the nonvolatile memory 610 into the memory 608 for running, to form a credit evaluation apparatus at the logical level. Certainly, in addition to software implementations, one or more embodiments of the present specification do not exclude other implementations, such as logic devices or a combination of hardware and software. That is, an execution body of the following processing procedure is not limited to logical units, but can also be hardware or logic devices.

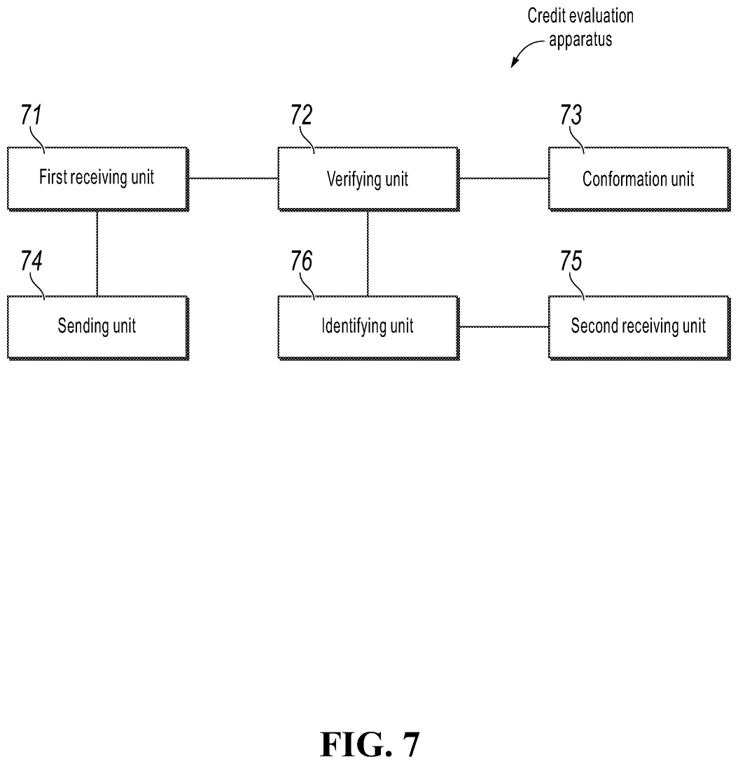

Referring to FIG. 7, in software implementations, the credit evaluation apparatus is applied to a verifier and can include the following: a first receiving unit 71, configured to receive a credit evaluation result to be verified and zero-knowledge proof information that are provided by a certifier; a verifying unit 72, configured to verify, based on the zero-knowledge proof information, whether the following conditions are satisfied: the credit evaluation result to be verified is generated by a credit evaluation function, and calculation parameters used to generate the credit evaluation result to be verified match a hash value recorded in a blockchain by an endorser, where the hash value corresponds to credit proof data of the certifier recorded by the endorser; and a confirmation unit 73, configured to confirm that the credit evaluation result to be verified is trustable when the zero-knowledge proof information satisfies the previously described conditions.

Optionally, the credit evaluation function is a default function, and the calculation parameters used by the credit evaluation function are default parameters; or the apparatus further includes a sending unit 74, configured to send instruction information to the certifier, to indicate the credit evaluation function to be used by the certifier and the calculation parameters of the credit evaluation function.

Optionally, the apparatus further includes the following: a second receiving unit 75, configured to receive a certificate of deposit that corresponds to the hash value and that is provided by the certifier, where the certificate of deposit is provided by the endorser to the certifier; and an identifying unit 76, configured to identify the hash value from the blockchain based on the certificate of deposit.

The system, apparatus, module, or unit described in the previously described embodiments can be implemented by a computer chip or an entity, or implemented by a product having a certain function. A typical implementation device is a computer, and the computer can be a personal computer, a laptop computer, a cellular phone, a camera phone, a smartphone, a personal digital assistant, a media player, a navigation device, an email receiving and sending device, a game console, a tablet computer, a wearable device, or any combination of these devices.

In typical configuration, the computer includes one or more processors (CPU), an input/output interface, a network interface, and a memory.

The memory can include a form of a volatile memory, a random access memory (RAM) and/or a nonvolatile memory, etc. in a computer readable medium, such as a read-only memory (ROM) or a flash memory (flash RAM). The memory is an example of the computer readable medium.

The computer readable medium includes volatile and nonvolatile, removable and non-removable media, and can store information by using any method or technology. The information can be a computer readable instruction, a data structure, a program module, or other data. Examples of the computer storage medium include but are not limited to a phase change random access memory (PRAM), a static RAM (SRAM), a dynamic RAM (DRAM), a RAM of another type, a read-only memory (ROM), an electrically erasable programmable ROM (EEPROM), a flash memory or another memory technology, a compact disc ROM (CD-ROM), a digital versatile disc (DVD), or another optical storage, a cassette, a magnetic disk storage, a quantum memory, a graphene-based storage medium, or another magnetic storage device or any other non-transmission medium. The computer storage medium can be configured to store information that can be accessed by the computing device. Based on the definition in the present specification, the computer readable medium does not include a transitory computer readable medium (transitory media), for example, a modulated data signal and carrier.

It is worthwhile to further note that, the terms “include”, “contain”, or their any other variants are intended to cover a non-exclusive inclusion, so that a process, a method, a product, or a device that includes a list of elements not only includes those elements but also includes other elements which are not expressly listed, or further includes elements inherent to such process, method, product, or device. Without more constraints, an element preceded by “includes a . . . ” does not preclude the existence of additional identical elements in the process, method, product, or device that includes the element.

Specific embodiments of the present specification are described above. Other embodiments fall within the scope of the appended claims. In some situations, the actions or steps described in the claims can be performed in an order different from the order in the embodiments and the desired results can still be achieved. In addition, the process depicted in the accompanying drawings does not necessarily need a particular execution order to achieve the desired results. In some implementations, multi-tasking and concurrent processing is feasible or can be advantageous.

Terms used in one or more embodiments of the present specification are merely used to describe specific embodiments, and are not intended to limit the one or more embodiments of the present specification. The terms “a” and “the” of singular forms used in one or more embodiments of the present specification and the appended claims are also intended to include plural forms, unless otherwise specified in the context clearly. It should be further understood that the term “and/or” used in the present specification indicates and includes any or all possible combinations of one or more associated listed items.

It should be understood that although terms “first”, “second”, “third”, etc. can be used in one or more embodiments of the present specification to describe various types of information, the information is not limited to these terms. These terms are only used to differentiate between information of the same type. For example, without departing from the scope of one or more embodiments of the present specification, first information can also be referred to as second information, and similarly, the second information can be referred to as the first information. Depending on the context, for example, the word “if” used here can be explained as “while”, “when”, or “in response to determining”.

The previous descriptions are merely example embodiments of the present specification, but are not intended to limit the present specification. Any modification, equivalent replacement, or improvement made without departing from the spirit and principle of the present specification shall fall within the protection scope of the present specification.

What is claimed is:

1. A computer-implemented method, comprising:
obtaining, by a certifier, credit proof data provided by an endorser, wherein a hash value corresponding to the credit proof data is recorded in a blockchain by the endorser;
applying, by the certifier, a credit evaluation function to the credit proof data to obtain a credit evaluation result to be verified;
generating, by the certifier, zero-knowledge proof information for the credit evaluation result to be verified; and
sending, by the certifier, the credit evaluation result to be verified and the zero-knowledge proof information to a verifier that confirms the credit evaluation result to be trustable when the verifier determines, based on the zero-knowledge proof information, that:
the credit evaluation result to be verified is generated by the credit evaluation function; and
calculation parameters of the credit evaluation function used to generate the credit evaluation result to be verified match the hash value corresponding to the credit proof data.

2. The computer-implemented method of claim 1, further comprising:
receiving, from the verifier, instruction information to determine the credit evaluation function to be used and the calculation parameters of the credit evaluation function; and
determining, by the certifier, based on the instruction information, the credit evaluation function to be used and the calculation parameters of the credit evaluation function.

3. The computer-implemented method of claim 1, further comprising:
obtaining a certificate of deposit that corresponds to the hash value and that is provided by the endorser; and
sending the certificate of deposit to the verifier so that the verifier identifies the hash value from the blockchain based on the certificate of deposit;
wherein the certificate of deposit comprises at least one of the following: the hash value and a recording location of the hash value in the blockchain.

4. The computer-implemented method of claim 1, wherein the hash value is obtained by the endorser by hashing the credit proof data and a random number, and the method further comprises:
obtaining the random number that corresponds to the hash value and that is provided by the endorser; and
verifying a mapping relationship between the credit proof data, the random number, and the hash value.

5. A computer-implemented method, comprising:
receiving, by a verifier, a credit evaluation result to be verified and zero-knowledge proof information that are provided by a certifier;
verifying, based on the zero-knowledge proof information, whether:
the credit evaluation result to be verified is generated by a credit evaluation function; and
calculation parameters used to generate the credit evaluation result to be verified match a hash value recorded in a blockchain by an endorser, wherein the hash value corresponds to credit proof data of the certifier recorded by the endorser; and
confirming, by the verifier, that the credit evaluation result to be verified is trustable when the verifier determines, based on the zero-knowledge proof information, that:
the credit evaluation result to be verified is generated by the credit evaluation function; and
calculation parameters of the credit evaluation function used to generate the credit evaluation result to be verified match the hash value corresponding to the credit proof data.

6. The computer-implemented method of claim 5, the method further comprising:
sending, to the certifier, instruction information to indicate the credit evaluation function to be used by the certifier and the calculation parameters of the credit evaluation function.

7. The computer-implemented method of claim 5, further comprising:
receiving, from the certifier, a certificate of deposit that corresponds to the hash value, wherein the certificate of deposit is provided by the endorser to the certifier; and
identifying the hash value from the blockchain based on the certificate of deposit.

8. A computer-implemented system, comprising:
one or more computers; and
one or more non-transitory computer memory devices interoperably coupled with the one or more computers and having tangible, non-transitory, machine-readable media storing instructions that, when executed by the one or more computers, cause the one or more computers to perform operations comprising:
obtaining, by a certifier, credit proof data provided by an endorser, wherein a hash value corresponding to the credit proof data is recorded in a blockchain by the endorser;
applying, by the certifier, a credit evaluation function to the credit proof data to obtain a credit evaluation result to be verified;
generating, by the certifier, zero-knowledge proof information for the credit evaluation result to be verified; and
sending, by the certifier, the credit evaluation result to be verified and the zero-knowledge proof information to a verifier that confirms the credit evaluation result to be trustable when the verifier determines, based on the zero-knowledge proof information, that:
the credit evaluation result to be verified is generated by the credit evaluation function; and
calculation parameters of the credit evaluation function used to generate the credit evaluation result to be verified match the hash value corresponding to the credit proof data.

9. The computer-implemented system of claim 8, the operations further comprising:
receiving, from the verifier, instruction information to determine the credit evaluation function to be used and the calculation parameters of the credit evaluation function; and
determining, by the certifier, based on the instruction information, the credit evaluation function to be used and the calculation parameters of the credit evaluation function.

10. The computer-implemented system of claim 8, the operations further comprising:
obtaining a certificate of deposit that corresponds to the hash value and that is provided by the endorser; and
sending the certificate of deposit to the verifier so that the verifier identifies the hash value from the blockchain based on the certificate of deposit;
wherein the certificate of deposit comprises at least one of the following: the hash value and a recording location of the hash value in the blockchain.

11. The computer-implemented system of claim 8, wherein the hash value is obtained by the endorser by hashing the credit proof data and a random number, and the operations further comprise:
obtaining the random number that corresponds to the hash value and that is provided by the endorser; and
verifying a mapping relationship between the credit proof data, the random number, and the hash value.

12. A non-transitory computer memory device having tangible, non-transitory, machine-readable media storing instructions that, when executed by one or more computers, cause the one or more computers to perform operations comprising:
obtaining, by a certifier, credit proof data provided by an endorser, wherein a hash value corresponding to the credit proof data is recorded in a blockchain by the endorser;
applying, by the certifier, a credit evaluation function to the credit proof data to obtain a credit evaluation result to be verified;
generating, by the certifier, zero-knowledge proof information for the credit evaluation result to be verified; and
sending, by the certifier, the credit evaluation result to be verified and the zero-knowledge proof information to a verifier that confirms the credit evaluation result to be trustable when the verifier determines, based on the zero-knowledge proof information, that:
the credit evaluation result to be verified is generated by the credit evaluation function; and
calculation parameters of the credit evaluation function used to generate the credit evaluation result to be verified match the hash value corresponding to the credit proof data.

13. The non-transitory computer memory device of claim 12, the operations further comprising:
receiving, from the verifier, instruction information to determine the credit evaluation function to be used and the calculation parameters of the credit evaluation function; and
determining, by the certifier, based on the instruction information, the credit evaluation function to be used and the calculation parameters of the credit evaluation function.

14. The non-transitory computer memory device of claim 12, the operations further comprising:
obtaining a certificate of deposit that corresponds to the hash value and that is provided by the endorser; and
sending the certificate of deposit to the verifier so that the verifier identifies the hash value from the blockchain based on the certificate of deposit;
wherein the certificate of deposit comprises at least one of the following: the hash value and a recording location of the hash value in the blockchain.

15. The non-transitory computer memory device of claim 12, wherein the hash value is obtained by the endorser by hashing the credit proof data and a random number, and the operations further comprise:
obtaining the random number that corresponds to the hash value and that is provided by the endorser; and
verifying a mapping relationship between the credit proof data, the random number, and the hash value.
